(19) United States
(12) Patent Application Publication
(10) Pub. No.: US 2025/0144957 A1
(43) Pub. Date: May 8, 2025

(54) DECORATIVE ARTICLE, VEHICLE, OBJECT AND METHOD FOR MANUFACTURING A DECORATIVE ARTICLE

(71) Applicant: F. LIST GMBH, Thomasberg (AT)

(72) Inventors: Andreas Prantl, Zemendorf (AT); Lukas Delbeck, Wiener Neustadt (AT); Andreas Brandner, Katzelsdorf (AT); Patrick Domnanich, Wien (AT)

(73) Assignee: F. LIST GMBH, Thomasberg (AT)

(21) Appl. No.: 19/013,741

(22) Filed: Jan. 8, 2025

Related U.S. Application Data
(63) Continuation of application No. PCT/EP2022/069943, filed on Jul. 15, 2022.

(51) Int. Cl. B44C 5/04; B29C 39/02; B29C 39/12; B29C 39/26; B29L 31/00

(52) U.S. Cl. CPC B44C 5/0453; B29C 39/026; B29C 39/123; B29C 39/26; B29K 2995/0016; B29K 2995/0082; B29L 2031/722

(57) ABSTRACT

The invention relates to a decorative article for decoratively covering at least a portion of one or more objects, including a plurality of discrete islands made of at least one first material and at least one base layer made of at least one second material. The base layer is substantially flexible and the islands are attached to at least a first base layer surface of the base layer at discrete positions on the first base layer surface such that the decorative article is flexible in regions between the islands. The invention further relates to an object at least partially covered by a decorative article, a vehicle including an interior in which one or more objects, which are at least partially covered by a decorative article are arranged, and a method for manufacturing a decorative article.

### CROSS-REFERENCE TO RELATED APPLICATIONS

This application is a continuation of International Application No. PCT/EP2022/069943, filed Jul. 15, 2022, the contents of which is herein incorporated by reference in its entirety.

### BACKGROUND

Providing an aesthetically appealing appearance in an interior of a vehicle, such as an aircraft, a watercraft and/or a land-bound vehicle, is considered to play a relatively important role when configuring the respective vehicle. Many vehicles, such as aircrafts, typically travel across relatively long distances such that the occupants spend a relatively large amount of time in the vehicles. Hence, providing a comfortable and appealing environment to the occupants of the vehicle may be considered a relatively important aspect, in particular for customer satisfaction. Moreover, many owners of vehicles may have a desire to personalize the interior of their vehicle(s), which may be achieved by providing customized decorative articles in the interior of their respective vehicle.

Decorative articles may be used to cover various surfaces in an interior of a vehicle. For instance, decorative articles may be used to cover walls, furniture and/or generally any surface in the interior of the respective vehicle which may be visible to one or more occupants.

However, the decorative articles known from the prior art have several drawbacks. For instance, the decorative articles know from the prior art often only have a limited range of application. For instance, many known decorative articles are often limited in their application, e.g., many known decorative articles are often limited to being applied to certain objects having a certain shape and/or certain dimensions and/or a certain contour. Moreover, the decorative articles known from the prior art often allow only a relatively low degree of variability, e.g., in appearance. For instance, in order to achieve a desired degree of variability for the decorative articles know from the prior art, the concept, e.g., the structural concept, of the decorative articles generally must be adapted by a relatively large extent or must be changed altogether.

Thus, based on the prior art, there remains a need to improve such decorative articles, e.g., by improving or eliminating one or more drawbacks of the decorative articles know from the prior art, e.g., one or more of the above-identified drawbacks.

### BRIEF SUMMARY

It is therefore an object of the present invention to provide an improved decorative article.

This object is achieved by a decorative article as defined by the features of claim 1. Preferred embodiments are defined by the features of the respective dependent claims.

The decorative article may be configured to decoratively cover at least a portion of one or more objects. The decorative article may be configured to at least partially decoratively cover a variety of different objects, e.g., one or more pieces of furniture, one or more walls, and/or any other structure(s) for which an enhanced aesthetic appeal may be desirable. The decorative article may be configured to at least partially decoratively cover a wide range of objects having various sizes, shapes, material compositions, structural properties, e.g., roughness and/or hardness, and/or contours. The decorative article may be configured for upholstering the one or more objects, e.g., one or more pieces of furniture, one or more walls, and/or any other structure(s).

The decorative article may include a plurality of discrete islands made of at least one first material and at least one base layer made of at least one second material. The base layer may be substantially flexible, i.e., deformable, e.g., bendable and/or stretchable. Preferably, the base layer is elastically stretchable. The base layer may be flexible, e.g., bendable, but substantially non-stretchable. Alternatively, the base layer may be flexible, e.g., bendable, including being stretchable, preferably elastically stretchable.

The islands may be attached to at least a first base layer surface of the base layer at discrete positions on the first base layer surface such that the decorative article is flexible in regions between the islands.

The configuration of the decorative article described herein, in particular having the above-identified features, may allow the decorative article to be adaptively applied to objects having a wide range of different shapes and/or different dimensions and/or different contours, in particular due to the flexibility provided to the decorative article in regions between the islands. In contrast to conventional decorative articles known from the prior art, the decorative article described herein may allow a flexibility, preferably at least a stretchability, of the decorative article to be adjusted and/or tailored to a certain degree or range, e.g., a required and/or desired degree of flexibility, preferably stretchability. The flexibility of the decorative article may be provided primarily by the (second) material of the base layer.

Moreover, the touch and feel, i.e., the haptic properties, of the decorative article can be adjusted and/or tailored, e.g., by varying one or more materials and/or by varying an arrangement and/or configuration of the islands, to provide a high-quality and/or luxurious feel to the decorative article, e.g., by configuring at least a portion of the decorative article to be perceived as cold, hard and/or smooth, e.g., in contrast to the touch of conventional plastic surfaces.

Providing the discrete islands may allow the aesthetic appearance of the decorative article to be adapted and/or altered via one or more properties of the discrete islands, in particular of first material of the discrete islands and/or with respect to an arrangement and/or distribution of the islands on the base layer. Hence, the discrete islands, in particular the material(s) of the discrete islands, e.g., at least the one first material, may be chosen substantially independently of their flexibility properties, in particular since the flexibility of the decorative article may be provided, at least primarily, by one or more properties, in particular the flexibility, of the (second) material of the base layer. For instance, the discrete islands may be substantially rigid/non-flexible. The proposed articles may allow an integration of a wide range of different materials, e.g., to allow one or more properties of the decorative article, e.g., an appearance of the decorative article, to be varied to a relatively large degree in a relatively simple manner, e.g., by varying the material and/or material combination of the islands and/or the base layer. As described above, in order to achieve a desired degree of variability in the properties, e.g., the appearance, of the decorative articles know from the prior art, the concept, e.g., the structural concept, of the decorative articles generally must be adapted to a relatively large extent or must be changed altogether.

Moreover, the flexibility in the use of different materials, which is enabled by the configuration of the decorative article described herein, may allow one or more sustainable materials, e.g., recycled materials, upcycled materials and/or waste materials, to be implemented in the decorative article, e.g., in the islands and/or the base layer, to increase the eco-friendliness and/or to reduce the cost(s) of the decorative article.

By providing the islands discretely, i.e., at discrete locations on the base layer, the flexibility of the decorative article may be achieved at least in regions between the islands, even if the discrete islands, in particular the material(s) of the discrete islands, are substantially rigid/non-flexible. The islands may be substantially non-flexible which may substantially prevent the base layer from being deformed/flexed, e.g., from bending and/or stretching, or at least reduce such deformation/flexion with respect to properties of the base layer, in regions of the base layer on which one or more islands are arranged/fixed. Thus, the islands may be connected to the base layer at respective interface surfaces of the base layer, wherein the islands may prevent or at least limit the base layer from stretching/flexing at the interface surfaces. Thus, the decorative article may be flexible at least in regions of the base layer on which an island is not fixed.

The arrangement of the islands on the base layer may provide a desired optical appearance to the one or more objects, when the one or more objects are at least partially covered by the decorative article. For instance, the islands may be arranged in one or more patterns. Alternatively, or additionally, the islands may provide one or more colors and/or one or more visual effects, such as a mirrored effect and/or metallic effect, to the decorative article.

The base layer may be substantially continuous, i.e., uninterrupted, e.g., as a sheet or strip. Thus, the islands may be arranged at discrete locations on a substantially continuous base layer.

The base layer and/or the islands may be configured to be coatable by one or more substances, e.g., one or more substances which may provide a desired visual effect to the decorative article and/or one or more substances which protect the decorative article against one or more detrimental media, e.g., liquid and/or moisture.

Preferably, the base layer has a greater flexibility, preferably a greater elastic stretchability, than the islands. Thus, the islands may be connected to the base layer at respective interface surfaces of the base layer, wherein the islands may prevent or at least limit the base layer from stretching/flexing at the interface surfaces. Thus, the decorative article may be flexible in regions of the base layer on which an island is not arranged/fixed.

Preferably, the islands are arranged in at least one pattern, preferably at least one repeating pattern, in at least a section of the first base layer surface of the base layer.

Preferably, the islands are arranged irregularly in at least a section of the first base layer surface of the base layer. The islands may be arranged at arbitrary locations on the first base layer surface of the base layer, i.e., in a non-repeating manner and/or not following a pattern. This may further enhance the variability of the decorative article for providing relatively large differences in appearances from one decorative article to another decorative article by applying relatively simple means, i.e., through different arrangements/distributions of the islands on the base layer.

Preferably, the islands are shaped and/or dimensioned and/or distributed on the base layer and/or distanced from each other in a manner to control flexing and/or bending and/or stretching of the decorative article in at least one or more sections thereof. This may allow a degree of flexibility, e.g., bendability and/or stretchability, in at least a section decorative article to be altered and/or adapted and/or controlled. Thus, for instance, at least one first section of the decorative article may have a greater degree of flexibility than at least a second section of the decorative article based on different configurations of the islands in the first and second sections, e.g., by varying the shape and/or dimension(s) and/or distributions and/or the composition of the islands between the first section and the second section. This may be advantageous, e.g., for covering an object with different contours, e.g., varying bends and/or radii. Thus, various sections of the decorative article may be adapted and/or optimized for covering a respective section of the object to be at least partially covered.

Preferably, the islands are shaped and/or dimensioned and/or distributed on the base layer in a manner to vary one or more flexing characteristics and/or bending characteristics and/or stretching characteristics of the decorative article across the decorative article.

Preferably, based on a manner in which the islands are shaped and/or dimensioned and/or distributed on the base layer, at least one first section of the decorative article is configured to flex and/or bend and/or stretch: to a greater extent than at least one second section of the decorative article; and/or more easily in at least one first direction than in at least one second direction, and preferably wherein at least one second section of the decorative article is configured to flex and/or bend and/or stretch more easily in at least one direction, which is different from the first direction, than the first direction. This may enable, e.g., various sections of the decorative article to be adapted and/or optimized for covering a respective section of the object to be at least partially covered. This may allow one or more deformations of the decorative article to be effected, e.g., along one or more lines and/or in one or more areas of the decorative article, by applying only a relatively small amount of force. The language “to flex and/or bend and/or stretch more easily”, as referred to above, may be interpreted as allowing a greater degree of flexibility, when applying an identical load. For instance, the first section may flex by a greater degree when applying a load to the decorative article in the first direction than when applying the same load to the decorative article in the second direction. This may be advantageous, e.g., for covering an object with different contours, e.g., varying bends and/or radii. Thus, various sections of the decorative article may be adapted and/or optimized for covering a respective section of the object to be at least partially covered, as discussed above. Alternatively, or additionally, this may be advantageous for use with objects, e.g., for at least partially covering said objects, which morph during use of the respective object, e.g., by changing the shape, contour(s) and/or one or more dimensions of the respective object. For instance the decorative article may at least partially cover, preferably completely cover, i.e., without any substantial gaps in the decorative article, a tabletop area and a moveable device, e.g., a flap. The moveable device may be configured to be moved between at least two positions, e.g., an opened position and a stored position, wherein the islands of the decorative article may be configured to allow an opening and/or a storing movement of the device between the opened position and the stored position. Alternatively, or additionally, the decorative article may be configured to cover an object which includes a wireless charger which is moveable between a use position and a stowed position, e.g., in order to stow the wireless charger when the wireless charger is not in use. The wireless charger may be configured to be retracted at least partially into an interior of the object in the stowed position. For instance, when a device which is to be charged, e.g., a mobile device, is placed in the vicinity of the wireless charger, e.g., substantially above the wireless charger, the device may be recognized by one or more sensors and a recess, preferably a substantially rectangular shaped recess, may be formed in a surface of the object, which is at least partially covered by the decorative article, to accommodate, e.g., at least partially receive and/or house, the device while being charged. The islands of the decorative article may be configured to enable the recess to be formed by accommodating morphing, i.e., movement, of at least a portion of the object.

The extent to which the first section and the second section may flex and/or bend and/or stretch may be determined by applying an identical load to the decorative article to attempt to flex and/or bend and/or stretch the respective sections. For instance, the first section may flex and/or bend and/or stretch to a greater extent than the second section, when applying the same load to the decorative article for both sections.

Preferably, the islands are shaped and/or dimensioned and/or distributed on the base layer and/or distanced from each other in a manner to: facilitate a conformability of the decorative article to at least one contour of the one or more objects, at least a portion of which is to be decoratively covered by the decorative article; and/or substantially conform to at least one shape and/or one or more dimensions of the one or more objects, at least a portion of which is to be decoratively covered by the decorative article, wherein the one or more objects are configured such that the at least one shape and/or one or more dimensions can be altered, in a state in which the one or more objects are at least partially covered by the decorative article.

The islands may be configured to provide optical features to the decorative article, when a respective object is at least partially covered by the decorative article, wherein the optical features may be perceived as structural features, e.g., edges, borders, bends, gaps, etc., of the object to a user. For instance, the islands may be configured to include one or more features which are perceived as borders, e.g., an edge, of the respective object. Alternatively, or additionally, the islands may be configured to optically separate and/or connect one or more first sections of the object, when the object is at least partially covered by the decorative article, from one or more second sections of the object.

Preferably, the decorative article is configured to cover at least a portion of one or more objects which are configured to be arranged in an aircraft. At least a portion of the decorative may have been treated with at least one flame retardant. Preferably, the decorative article is configured for use in powered aircraft travel. The term “flame retardant” refers to one or more active flame retardant compounds. The one or more active flame retardant compounds may be included in a formulation which also include one or more additives, e.g., which may facilitate penetration of the flame retardant into the decorative article, e.g., as wetting agents, and/or which facilitate a production process, e.g., antimicrobials which may inhibit deterioration of the liquid flame retardant solution. However, the term “flame retardant”, within the context of the present disclosure, refers to the active flame retardant compounds as such, i.e., not including additives.

Preferably, the decorative article is configured to pass the vertical burn test. The vertical burn test may be performed as defined by the U.S. Federal Aviation Administration (FAA) in the Code of Federal Regulations (CFR), more specifically in CFR Title 14, Subchapter C, Appendix F to Part 25, Part I (a)(1)(i) in connection with CFR Title 14, Subchapter C, Appendix F to Part 25, Part I (b)(4), also known as the 60 second vertical burn test. Additionally, or alternatively, the vertical burn test may be performed pursuant to CFR Title 14, Subchapter C, Appendix F to Part 25, Part I (a)(1)(ii) in connection with CFR Title 14, Subchapter C, Appendix F to Part 25, Part I (b)(4), also known as the 12 second vertical burn test. The version of the above-identified Code of Federal Regulations (CFR) which is in force as of May 20, 2022 is to be applied.

Preferably, the base layer is elastically stretchable in at least two dimensions, which preferably lie in a single plane, when the base layer is arranged in or along the plane. This may further improve the adaptability and/or conformability of the decorative article, e.g., for covering an object with different contours, e.g., varying bends and/or radii.

Preferably, the decorative article is at least partially made by means of one or more casting processes. This may enable the decorative article to be manufactured relatively precisely and/or with a greater variability than, e.g., printing. For instance, a configuration of a casting form used for the one or more casting processes may be altered, e.g., by adjusting distances between openings provided in the casting form. Preferably, the islands are manufactured by casting material in a plurality of openings in a casting form, the shapes and/or dimensions of the openings at least partially corresponding to the shapes and/or dimensions of the produced islands.

Preferably, the islands are configured and arranged on the first base layer surface such that the decorative article, matches or at least resembles, at least optically, a structure of a natural material, preferably an animal skin. This may allow the appearance of natural materials, e.g., animal skin, to be imitated. This may allow the appearance of natural materials to be utilized, without accessing the natural materials, or only minimally accessing the natural materials. This may provide an environmentally friendly way of providing the appearance of natural materials to the decorative article. A natural material may be interpreted as a non-synthetic, i.e., non-man-made, material.

Preferably, the second material includes at least one of the following: a polymeric material, preferably an elastomer, a fleece material, preferably including at least one flame retardant substance, a textile material, a fiber composite material which is preferably embedded in an elastomer and preferably includes glass fibers. The first material may be made inorganic, preferably by at least 80 wt %, preferably at least 85 wt %, more preferably at least 90 wt %, with respect to a total weight of the second material and the first material, respectively.

Preferably, the base layer and/or the islands include(s) at least one flame retardant substance. The base layer and/or the islands and/or the entire decorative article may be treated with a flame retardant after they have been produced, respectively. Alternatively, or additionally, a flame retardant may be included, e.g., mixed in with, the first material, the second material and/or a further material used for producing the decorative article. The flame retardant substance may be inorganic or organic, preferably a phosphor-nitrogen-compound.

Preferably, the first material includes at least one inorganic compound which is preferably selected from one or more of the following: a glass powder (preferably including inorganic non-metallic glass, oxidic glass and/or silicate glass), a ceramic powder (i.e., an inorganic, non-metallic, poorly soluble and at least 30 wt % crystalline material), a non-oxide ceramic powder (e.g., powder from titanium carbonitride, titanium nitride, titanium carbide, boron cabide and the like), a metal oxide or metal oxide powder, mother of pearl powder, a rock flour or rock powder, a silicate mineral powder (preferably selected from the mineral classes of nesosilicates, sorosilicates, cyclosilicates, inosilicates, phyllosilicates or tectosilicates), a silicate-compound or silicate compound powder, a metal/metal alloy, a metal/metal alloy powder (e.g., copper, gold, silver, brass and/or bronze). Preferably, the inorganic material includes at least one recycled material and/or at least one upcycled material. Preferably, the first material includes at least one waste material, preferably from one or more production processes, e.g., from subtractive machining of metal, stone and/or ceramic parts.

Preferably, the inorganic compound is provided in the first material at least partially, preferably completely, in powder and/or particle form. If the first material is provided at least partially, preferably completely, in particle form, preferably, the average particle size, e.g., a d50 value or value range of the particles, is 1 μm to 1000 μm, more preferably 5 μm to 500 μm, more preferably 10 μm to 250 μm, more preferably 50 μm to 250 μm, most preferably 15 μm to 150 μm. The particles may be introduced into the first material as raw material particles and/or the particles may be functionalized with at least one coating, e.g., to enhance a compatibility and/or a suspension of the particles in a matrix of the first material and/or to adjust and/or tailor a hydrophilicity and/or a hydrophobicity of the particles. The coating may include non-ionic emulsifiers (e.g., ethers from fatty alcohols with polyglycol, (partial) esters of fatty acids with polyhydric alcohols), stearic acid, by reaction with phosphonic acid, functionalization with silanes, titanate coupling agents and the like.

Preferably, the first material includes at least one type of metal, preferably in particle and/or fiber form, preferably wherein the metal is dispersed in an epoxy resin. The first material preferably includes at least one binder, e.g., SKresin® 3220 or SKresin® 3221 provided by S u. K Hock GmbH, preferably an epoxy, and/or a liquid metal 2K epoxy.

Preferably, at least some of the islands have at least one surface which has been treated by means of at least one treatment process to alter one or more characteristics, preferably one or more optical characteristics, of the surface. This may further increase the aesthetic appearance of the islands, and thus of the decorative article. Thus, by varying the treatment process, the appearance of the islands and thus of the decorative article may be varied, which may increase the variability of the appearance of the decorative article with relatively simple means. Alternatively, or additionally, such treatment processes may be configured to protect the islands from one or more media, e.g., to prevent damage, e.g., corrosion, to the islands.

Preferably, at least some of the islands have at least one polished surface and/or sanded surface, preferably at least one polished surface and/or sanded surface which faces away from the base layer and/or which is arranged on a side of the islands which is opposite from the base layer.

The islands preferably have a certain minimum and/or maximum degree of hardness or hardness ranges, e.g., to provide an appealing haptic touch and/or a high-quality touch and/or a luxurious touch and/or to provide stability and/or rigidity to the islands, e.g., during handling and/or stretching of the decorative article. The shore hardness D of the islands is preferably at least 10, more preferably at least 50, most preferably at least 80.

Alternatively, or additionally, the inventors have found that it may be advantageous to configure the hardness of the islands depending on the size of the respective island(s). Surprisingly, it has been found by the inventors that the overall stability of the decorative article, e.g., during stretching and/or bending of the decorative article, having larger islands may benefit from a lower shore hardness of the material of the islands, whereas the overall stability of the decorative article having smaller islands may benefit from a higher shore hardness of the material of the islands. Preferably, the islands which each have a projected area, which is projected in a direction which is substantially perpendicular to the base layer, when the decorative article is not deformed, i.e., when the decorative article is spread out on a flat surface, of 10 mm or smaller have a shore hardness D of no more than 99, whereas the islands which each have a projected area of 10.01 mm² to 50 mm² have a shore hardness D of no more than 97. The islands which each have a projected area of 50.01 mm² to 100 mm² have a shore hardness D of no more than 94. The islands which each have a projected area of 100.01 mm² to 200 mm² have a shore hardness D of no more than 88. The islands which each have a projected area of 200.01 mm² to 300 mm² have a shore hardness D of no more than 82. The islands which each have a projected area of 300.01 mm² to 400 mm² have a shore hardness D of no more than 76. The islands which each have a projected area of 400.01 mm² to 500 mm² have a shore hardness D of no more than 70. The islands which each have a projected area of 500.01 mm² to 600 mm² have a shore hardness D of no more than 64. The islands which each have a projected area of 600.01 mm² to 700 mm² have a shore hardness D of no more than 58. The islands which each have a projected area of 700.01 mm² to 800 mm² have a shore hardness D of no more than 52. The islands which each have a projected area of 800.01 mm² to 900 mm² have a shore hardness D of no more than 46. The islands which each have a projected area of 900.01 mm² or more have a shore hardness D of no more than 40. The shore hardness can be determined as described in ASTM D2240, for instance.

Preferably, at least some of the islands have at least one surface, preferably a surface which faces away from the base layer and/or which is arranged on a side of the islands which is opposite from the base layer, which has a glossy finish and/or a polished finish and/or a sanded finish and/or a light reflective finish and/or a shiny finish. Such a finish, particularly a shiny finish, may be achieved by treating, e.g., polishing, at least a portion of the islands with sanding paper, preferably in the sequence of grit sizes of P400, P600, P800, P1200, P3000 and P6000 (e.g., using sanding papers by Kovax and/or Trizact).

Preferably, at least some of the islands have a gloss at 60 degrees of at least one surface of the respective island which is greater than 40, more preferably greater than 60, more preferably greater than 70, more preferably greater than 80 and most preferably greater than 90. The gloss at 60 degrees may be determined, for example, as described in DIN EN ISO 2813:2015-02.

Preferably, the decorative article further includes at least one coating which is provided on at least one surface of at least some of the islands, preferably a surface of the islands which faces away from the base layer and/or which is arranged on a side of the islands which is opposite from the base layer, and/or on at least a section of the base layer. The coating may be varnish with or without one or more flame retardant substances.

Preferably, the coating provides at least one of the following effects: increases the light reflective properties of the surface/section, alters the color of the surface/section, protects the surface/section, seals the surface/section, hardens the surface/section, alters one or more haptic properties of the surface/section, alters thermal conductivity and/or electric conductivity, prevents oxidation of one or more compounds (e.g. metal) within the islands, increases a bonding strength between the islands and the base layer.

Surprisingly, the inventors have found in experimental assessments in which users touched an outer surface of the decorative article that the perception that the user is touching a premium and/or high-quality article may increase with increasing thermal conductivity of the first material, i.e., of the islands, in particular since metallic surfaces, which generally has a relatively high thermal conductivity, e.g., compared with a plastic material in general, are generally associated with more premium and/or high-quality products. The thermal conductivity of the first material, i.e., of the islands, may be increased by increasing a content of one or more inorganic compounds in the islands, e.g., in the first material, preferably by material which has a relatively high density, more preferably by material including silicate and/or rock particles, more preferably by one or more metal particles. Preferably, the thermal conductivity of the first material at atmospheric pressure and at 293 K is greater than 0.8 W/(m K), more preferably greater than 0.9 W/(m K), more preferably greater than 1.0 W/(m K), more preferably greater than 1.2 W/(m K), more preferably greater than 1.5 W/(m K), more preferably greater than 2 W/(m K), more preferably greater than 5 W/(m K), most preferably greater than 10 W/(m K). Thermal conductivity, e.g., of the first material and/or of the islands, may be determined as described in DIN EN ISO 22007-2:2015-12, for example.

Preferably, the decorative article is configured to decoratively cover at least a portion of one or more objects whose shape and/or dimensions may be altered, in a state in which the one or more objects are at least partially covered by the decorative article. The decorative article may be configured to substantially conform to the altered shape and/or the altered dimensions of the one or more objects. This may enable, e.g., the one or more objects to be adjusted and/or adapted according to a particular situation and/or a user's desire. For instance, a user may adjust a section of a piece of furniture, e.g., an inclination of an armrest. Alternatively, or additionally, an object, such as a support structure, may be extended, e.g., elongated, in at least one dimension, e.g., to increase an area of a support surface of the support structure. The decorative article may be configured to conform to such alterations of the one or objects, in a state in which the one or more objects are at least partially covered by the decorative article.

Preferably, the shape and/or dimensions of the one or more objects may be altered by flexing and/or bending and/or stretching, preferably elastically stretching, the one or more objects. The one or more objects may be alterable/adjustable in a passive manner, e.g., through manual adjustment by the user, and/or in an active manner, e.g., via one or more actuators included in the one or more objects.

Preferably, the decorative article has an elongation at break in at least one dimension, preferably at least two dimensions, which preferably lie in a single plane, when the base layer is arranged in or along the plane, of up to 70%, more preferably up to 60%, more preferably up to 50%, more preferably up to 45%, more preferably up to 40%, more preferably up to 35%, more preferably up to 30%, more preferably up to 25%, more preferably up to 20%, more preferably up to 15%, more preferably between 5% and 15%, most preferably between 7% and 12%. The elongation at break may be determined performed according to DIN EN ISO 1421:2017-03 and/or DIN EN ISO 13934-1:2013-08, for instance.

Preferably, the decorative article is configured such that the decorative article is stretchable only in regions of the decorative article which are arranged at least partially between the islands. This may further ensure that the islands remain securely attached to the base layer, or at least reduce the risk of the islands detaching or loosening from the base layer, as the decorative article is being deformed/flexed, e.g., bent and/or stretched.

Preferably, the decorative article has a tensile strength of at least 10 N/mm², preferably at least 15 N/mm², more preferably at least 20 N/mm², most preferably at least 25 N/mm² in at least one dimension in which the decorative article is elastically stretchable. The tensile strength of the decorative article may be determined in accordance with DIN EN ISO 1421:2017-03, for example.

Preferably, the islands are configured as projections which extend from the first base layer surface of the base layer. This may enhance the haptic and/or visual qualities of the decorative articles, which may make the decorative feel and/or look more “natural”, e.g., such as real leather, to the user. This may also allow provide a relatively large volume to the islands, e.g., to increase their visibility. Alternatively, or additionally, configuring the islands as projections may provide a certain minimum ratio, e.g., a relatively high ratio, of height of the islands, i.e., in a direction which is substantially perpendicular to the base layer, to width of the islands, i.e., in a direction which is substantially parallel to the base layer, which may increase the visibility of the islands and/or enhance the flexibility of the decorative article, e.g., by increasing a size of one or more gaps between adjacent islands. Moreover, this may facilitate providing one or more treatments, such as by polishing and/or coating, to the islands, e.g., due to their enhanced accessibility by extending from the first base layer surface of the base layer.

Preferably, each projection is tapered in a direction in which the projections extend from the first base layer surface of the base layer. This may further enhance the haptic and/or visual qualities of the decorative articles. Moreover, this may prevent, or at least reduce the risk of, undercuts, in particular in case the decorative article, specifically at least the islands, is/are at least partially made by means of one or more casting processes. This may improve the quality and/or properties of the islands.

Preferably, each projection has at least one flank, which extends from the first base layer surface of the base layer. The flank may form an angle with a section of the first base layer surface, the projection being attached to said section, which is less than 90°, preferably less than 85°, and preferably greater than 75°. The angle may be measured between the flank and a section of the first base layer surface of the base layer, the concerned island being arranged/attached on said section of the first base layer surface of the base layer. The angle may be measured when the decorative article is not deformed, i.e., when the decorative article is spread out on a flat surface.

Preferably, each projection has a base surface, at which the projection is attached to the first base layer surface of the base layer, which has a total area from 1 mm² to 500 mm², preferably from 1 mm² to 400 mm², more preferably from 1 mm² to 350 mm², more preferably from 1 mm² to 300 mm², more preferably from 1 mm² to 250 mm², more preferably from 1 mm² to 200 mm², more preferably from 1 mm² to 150 mm², more preferably from 1 mm² to 100 mm², more preferably from 1 mm² to 90 mm², more preferably from 1 mm² to 80 mm², more preferably from 1 mm² to 70 mm², more preferably from 1 mm² to 60 mm², more preferably from 1 mm² to 50 mm², more preferably from 1 mm² to 40 mm², more preferably from 1 mm² to 30 mm², more preferably from 1 mm² to 20 mm², more preferably from 2 mm² to 20 mm², more preferably from 3 mm² to 20 mm², most preferably from 4 mm² to 20 mm². The above-identified ranges may provide a secure connection between the islands and the base layer surface of the base layer, while limiting an extension of the islands along the first base layer surface of the base layer, which may increase the flexibility of the decorative article, in particular when the islands are rigid/non-flexible or are at least less flexible than the base layer. The above-identified ranges may apply to each island. Alternatively, or additionally, the above-identified ranges may be averages of all of the islands provided by the decorative article.

Preferably, each projection has a height, in a direction in which the projections extend from the first base layer surface of the base layer and/or in a direction which extends substantially perpendicularly to the first base layer surface, from 0.1 mm to 3 mm, more preferably from 0.15 mm to 3 mm, more preferably from 0.2 mm to 3 mm, more preferably from 0.25 mm to 3 mm, more preferably from 0.25 mm to 2.7 mm, more preferably from 0.3 mm to 2.6 mm, more preferably from 0.35 mm to 2.6 mm, more preferably from 0.4 mm to 2.5 mm, more preferably from 0.45 mm to 2.4 mm, more preferably from 0.5 mm to 2.3 mm, more preferably from 0.55 mm to 2.2 mm, more preferably from 0.6 mm to 2.1 mm, more preferably from 0.65 mm to 2 mm, most preferably from 1 mm to 2 mm. Providing each projection with a height having one of the above-described ranges may provide a pleasing, e.g., relatively comfortable and/or high-quality, touch for a user, while also limiting a surface of attack of the projections, e.g., by external structures, such as a portion of the user's body and/or garment(s), which may damage and/or dislodge the projections from the based layer. This may also reduce or limit a lever for external forces, which may reduce a moment acting on the projections via the external forces, which may provide a relatively durable connection between the islands and the base layer.

Preferably, each projection has one or more rounded edges at one or more sections of the projections, preferably at a distal section of the projection. This may increase the haptic properties of the decorative article and/or reduce the risk of injury and/or damage caused to users and/or other objects which may come into contact with the decorative article, which may be caused by sharp edges on the projections. Moreover, this may prevent the projections from catching on other objects and/or humans, which may cause the projections from detaching or loosening from the base layer. Moreover, the one or more rounded edges, which may be present at least prior to any postprocessing steps such as sanding, may facilitate the manufacturing process of the island, in particular when the decorative article, in particular the island(s), is/are obtained at least partially by means of one or more casting processes, in particular since the rounded edges may facilitate the removal of the casted portions of the decorative article, e.g., at least the islands, from the respective casting mold. Preferably, at least some of the projections, preferably all of the projections, have one or more rounded edges which have a radius which is greater than 0.05 mm, more preferably greater than 0.1 mm.

Preferably, each projection has a top face, which is arranged on a side of the projection which is opposite from the first base layer surface of the base layer and/or which extends substantially parallel to the first base layer surface of the base layer. The top face may define a surface which lies substantially in a single plane, wherein the plane extends substantially parallel to the first base layer surface of the base layer.

Preferably, the projections have an average width from 0.1 mm to 50 mm, preferably from 0.1 mm to 25 mm, preferably from 0.1 mm to 22 mm, more preferably from 0.1 mm to 20 mm, more preferably from 0.2 mm to 15 mm, more preferably from 0.3 mm to 12 mm, more preferably from 0.3 mm to 10 mm, more preferably from 0.4 mm to 9 mm, more preferably from 0.4 mm to 8 mm, more preferably from 0.5 mm to 7 mm, more preferably from 0.5 mm to 6 mm, more preferably from 0.5 mm to 5 mm, most preferably from 0.5 mm to 4 mm. The width may extend in a direction which is substantially parallel to the first base layer surface of the base layer, when the decorative article is spread out on a flat surface. The average width may be determined by measuring the width along each projection at multiple equidistant locations, preferably along a height of the projections, and calculating the average therefrom.

Preferably, adjacent islands are spaced from each other by a distance from 0.2 mm to 5 mm, preferably from 0.5 mm to 5 mm, preferably from 0.5 mm to 4 mm, more preferably from 0.5 mm to 3.5 mm, more preferably from 0.5 mm to 3 mm, more preferably from 0.5 mm to 2.5 mm, most preferably from 0.5 mm to 1.5 mm. The distance may be determined at the shortest distance between adjacent islands, preferably at a base of the respective islands, the base of the respective islands adjoining and/or facing the base layer.

Preferably, the base layer has a thickness which is at least 0.1 mm, preferably at least 0.2 mm, more preferably from 0.2 mm to 2 mm, more preferably from 0.2 mm to 1.5 mm, more preferably from 0.2 mm to 1 mm, most preferably from 0.3 mm to 0.8 mm. Preferably the base laser has a maximum thickness of 2 mm, more preferably 1.5 mm, more preferably 1 mm.

Preferably, the decorative article includes intermediate regions which are arranged substantially between adjacent islands. The intermediate regions may be interconnected, preferably across the entire decorative article, preferably in a web-like manner. The intermediate regions may include a void or empty space and/or a material, e.g., the first material or a further material, e.g., a coating material, a varnish, in particular a colored varnish, arranged substantially between the islands

The object set out at the beginning is also solved by an object defined by the features of claim 43. Preferably, the object is configured as a piece of furniture or a wall element, the object preferably being configured to be arranged in an interior of a vehicle, preferably an aircraft or a watercraft. The object is at least partially covered by a decorative article according to any of the embodiments described herein.

The features, configurations and/or advantages described above in relation to the decorative article also apply to the object accordingly.

The object set out at the beginning is also solved by a vehicle defined by the features of claim 44. The vehicle is preferably an aircraft or a watercraft. The vehicle has an interior in which one or more objects, which are at least partially covered by a decorative article according to any of the embodiments described herein, are arranged.

The features, configurations and/or advantages described above in relation to the decorative article also apply to the vehicle accordingly.

The object set out at the beginning is also solved by a method defined by the features of claim 45. The method is configured for manufacturing a decorative article configured to decoratively cover at least a portion of one or more objects. The method is preferably configured for manufacturing a decorative article according to any of the embodiments described herein.

The method includes the steps of:
(a) providing a mold having a plurality of recesses which are separated from each other by one or more walls;
(b) applying at least one first material to the mold such that at least a portion of the respective recesses is filled with a deposit of first material;
(c) removing excess first material which is arranged outside of the recesses, if said excess first material is present;
(d) applying at least one second material to the mold to provide a base layer, which is substantially flexible and on which the deposits of the first material are attached; and
(e) removing the first material and the second material from the mold; The decorative article includes a base layer and a plurality of discrete islands made of the first material attached to a first base layer surface at discrete positions on the first base layer surface is provided. The decorative article is elastically stretchable in regions of the base layer which are arranged at least partially between the islands.

Preferably, step (b) is performed on a vibrating surface, such as vibrating table. This may facilitate spreading, preferably even spreading, and/or filling of the first material in the recesses. Furthermore, it facilitates a removal of air bubbles which may be present in the first material. A frequency of vibration can be optimized to achieve the best spreading results and removal of air bubbles. Furthermore, ultrasound vibration frequencies may be employed in step (b). To facilitate spreading and/or air bubble removal, step b) may be performed at elevated ambient temperatures, preferably at a temperature greater than 30° C., more preferably greater than 40° C. To prevent premature curing, the temperature is preferably less than 80° C., more preferably less than 70° C., more preferably less than 60° C., most preferably less than 50° C. Moreover, to facilitate removal of gases during the manufacturing process, e.g., from the first material, instead of ambient air, the process may be performed in a specific gas atmosphere, preferably in a nitrogen atmosphere.

Preferably, step c) is performed such that the first material in separate recesses of the mold is substantially separated, i.e., such that the first material is not interconnected between recesses. In other words, the first material is preferably separated, i.e., not interconnected, from one recess to an adjacent recess by removing excess first material. The excess first material may be removed in step c) in such a manner that one or more walls of the mold extend beyond a fill level of the first material in the respective recesses after removal of the excess first material. For instance, a spatula, preferably a soft spatula, may be employed in step c) to remove excess first material in the manner described above.

Preferably, at least prior to step (e), the first material and/or the second material is/are cured in one or more curing steps. Preferably, the second material remains flexible/deformable, preferably elastically stretchable, after curing and/or the first material is substantially non-flexible/rigid after curing. The curing may effect at least partial cross-linking of the first material and/or the second material. The curing may result in an at least partial attachment of the first material to the second material, e.g., via a physical attachment and/or or a chemical attachment.

Preferably, at least one surface of at least some of the islands, preferably at least one surface which faces away from the base layer and/or which is arranged on a side of the islands which is opposite from the base layer, and/or at least one surface of the base layer is/are treated in one or more treatments steps to alter one or more characteristics, preferably one or more optical characteristics, of the respective surface.

Preferably, at least one surface of at least some of the islands, preferably at least one surface which faces away from the base layer and/or which is arranged on a side of the islands which is opposite from the base layer, and/or at least one surface of the base layer is/are treated by polishing and/or sanding and/or coating the respective surface.

Preferably, one or more flame retardants is/are added to at least one of the following: the first material, the second material, the base layer, the base layer first surface, and the islands. The flame retardant(s) may be applied after step e), wherein the flame retardant(s) may be included in at least one varnish and/or at least one coating which is applied to one or more portions of the decorative article after step e).

Preferably, the decorative article includes intermediate regions which are arranged substantially between adjacent islands, where the intermediate regions are interconnected, preferably across the entire decorative article, wherein at least some of the intermediate regions are preferably treated in one or more treatments steps to alter one or more characteristics, preferably one or more optical characteristics, of at least one surface of the intermediate regions.

Preferably, the mold is at least partially made of silicone.

Preferably, the recesses are configured and arranged to shape and/or arrange the islands on the first base layer surface such that the decorative article matches or at least resembles, at least optically, a structure of a natural material, preferably an animal skin. A natural material may be interpreted as a non-synthetic, i.e., non-man-made, material.

Preferably, the recesses are configured and arranged to provide a shape and/or an arrangement of the islands on the first base layer surface such that the decorative article matches or at least resembles a certain appearance, e.g., a certain pattern, which may be designed via a parametric design, preferably via a propagation based parametric design.

Preferably, the appearance, e.g., the pattern, may be designed via one or more algorithms that segment the decorative article into individual segments, preferably segments which each have a polygonal shape, preferably a polygon with rounded edges, most preferably segments which each have a freeform shape. Alternatively, or additionally, the islands may be arranged in a form that mimic a picture and/or a photo, e.g., by using smaller islands to correspond to darker sections of the photo and larger islands to correspond to one or more brighter sections of the photo.

Preferably, the second material includes at least one of the following: a polymeric material, preferably an elastomer, more preferably a silicone rubber, more preferably polyisoprene, more preferably rubber (preferably natural rubber), more preferably ethylene vinyl acetate copolymer, more preferably styrene-butadiene rubber, more preferably acrylonitrile-butadiene rubber, more preferably natural rubber, more preferably polychloroprene rubber, more preferably butyl rubber, more preferably ethylene propylene diene monomer rubber, more preferably polyurethan. Preferably, the second material includes at least one of the above-identified materials in vulcanized form and/or at least one of the above-identified materials in non-vulcanized form.

Alternatively, or additionally, the second material may include one or more reinforcement materials of the following: a fleece material, a glass fleece, a fiber composite, a textile material, and a web. The reinforcement material(s) may be arranged adjacent to a polymer, e.g., in a layered manner, and/or may be embedded within a polymer. The reinforcement material(s) may provide a reinforcing effect to the decorative material, in particular to the base layer, to increase the ultimate tensile strength and/or tear resistance of the decorative article.

Alternatively, or additionally, the second material may include at least one flame retardant substance.

If the second material includes a polymer, the polymer, in a cured, i.e., crosslinked, state of the polymer, preferably has an elongation at break of at least 50%, more preferably at least 80%, more preferably at least 100%, more preferably at least 200%, more preferably at least 300%, more preferably at least 400%, more preferably at least 500%, more preferably at least 600%, most preferably between 400% and 800%. The use of such a polymer may provide desired and/or required stretch properties, e.g., to enable covering of objects which have different contours, e.g., varying bends and/or radii and/or which morph during use, and/or mechanical characteristics to the decorative article, particularly to the second material, e.g., such that the second material still exhibits a sufficient and/or desired degree of strength even when treated with one or more flame retardants. The elongation at break of the respective material(s) is generally determined under the same conditions of testing temperature, testing pressure and testing duration and—if used—with the same concentration of a hardener and/or crosslinking agent. Preferably, the elongation at break of the polymer is determined based on the polymer in its purest form, i.e., without any substance additives and/or further materials. The elongation at break may be determined in accordance with ISO 37:2017, for instance.

If the second material includes a polymer, the polymer, in a cured, i.e., crosslinked, state of the polymer, preferably has a tensile strength of at least 0.2 MPa, more preferably at least 0.5 MPa, more preferably at least 1 MPa, more preferably at least 1.2 MPa, more preferably at least 1.5 MPa, more preferably at least 5 MPa, more preferably at least 3 MPa, more preferably at least 10 MPa. The use of such a polymer may provide desired and/or required stretch properties, e.g., to enable covering of objects which have different contours, e.g., varying bends and/or radii and/or which morph during use, and/or mechanical characteristics to the decorative article, in particular to the second material, e.g., such that the second material still exhibits a sufficient and/or desired degree of strength even when treated with one or more flame retardants. The tensile strength of the respective material(s) is generally determined under the same conditions of testing temperature, testing pressure and testing duration and—if used—with the same concentration of a hardener and/or crosslinking agent. Preferably, the tensile strength of the polymer is determined based on the polymer in its purest form, i.e., without any substance additives and/or further materials. The tensile strength may be determined in accordance with ISO 527:2019, for instance.

If the second material includes a polymer, the polymer, in a cured, i.e., crosslinked, state of the polymer, preferably has a shore hardness A of 5 to 98, more preferably 10 to 98, more preferably 20 to 95, more preferably 30 to 95, more preferably 35 to 95, most preferably 30 to 70, most preferably 30 to 50. The use of such a polymer may provide desired and/or required stretch properties, e.g., to enable covering of objects which have different contours, e.g., varying bends and/or radii and/or which morph during use, and/or mechanical characteristics to the decorative article, in particular to the second material, e.g., such that the second material still exhibits a sufficient and/or desired degree of strength when treated with one or more flame retardants. The shore hardness A of the respective material(s) is generally determined under the same conditions of testing temperature, testing pressure and testing duration and—if used—with the same concentration of a hardener and/or crosslinking agent. Preferably, the shore hardness A of the polymer is determined based on the polymer in its purest form, i.e., without any substance additives and/or further materials. The shore hardness A may be determined in accordance with ASTM D2240, for example.

If the second material includes a polymer, the polymer, in a cured, i.e., crosslinked, state of the polymer, preferably has a tear resistance which is greater than 2 N/mm, more preferably greater than 3 N/mm, more preferably greater than 4 N/mm, more preferably greater than 5 N/mm, more preferably greater than 6 N/mm. The use of such a polymer may provide desired and/or required stretch properties, e.g., to enable covering of objects which have different contours, e.g., varying bends and/or radii and/or which morph during use, and/or mechanical characteristics to the decorative article, in particular to the second material, e.g., such that the second material still exhibits a sufficient and/or desired degree of strength when treated with one or more flame retardants. The tear resistance of the respective material(s) is generally determined under the same conditions of testing temperature, testing pressure and testing duration and—if used—with the same concentration of a hardener and/or crosslinking agent. Preferably, the tear resistance of the polymer is determined based on the polymer in its purest form, i.e., without any substance additives and/or further materials. The tear resistance may be determined in accordance with DIN ISO 34-1:2016-09, for example.

Suitable and advantageous flame retardants for the second material may include one or more of the following: antimony trioxide, (nano)clay, flame retardants based on montmorillonite, organomodified silicates (e.g. Nanobent or Nanofill), aluminium hydroxide, zinc borate, borate, one or more further borate compounds, ammonium monophosphate, ammonium polyphosphate, aluminum hydroxide, ammonium polyphosphate, calcium carbonate, gypsum, calcium sulfate hemihydrate, organic phosphonic acid ester, such as CAS No. 3001-98-7.

Alternatively, or additionally, the flame retardant(s) for the second material may include at least one phosphorus compound, preferably at least one nitrogen phosphorus compound, most preferably at least one phosphorus compound and at least one nitrogen compound.

Alternatively, or additionally, if the second material, preferably an elastomer of the second material, includes a polyurethan, the flame retardant(s) for the second material preferably includes at least one phosphorus compound, preferably at least one nitrogen phosphorus compound, most preferably at least one phosphorus compound and at least one nitrogen compound. The nitrogen phosphorus compound may include one or more of the following: amino phosphate, amino phosphonate, ammonium polyphosphate, ammonium phosphate, organic amino phosphate, even more preferably organic amino phosphonate (e.g. Diethyl-bis(2-hydroxyethyl), aminomethylphosphonate, salt of amines, urea-derivates with phosphorcontaining acids, and salt of urea derivates with organic phosphonic ester. The phosphorus compound may include one or more of the following phosphates: phosphate, phosphoric acid organic phosphate, e.g., alkyl phosphate oligomer, such as, CAS No. 184538-58-7, triethyl ester of phosphoric acid, aromatic phosphate ester, phosphorus polyol, OH-terminated phosphorus polyol, diphenyl phenyl phosphate (DPK), cresyl diphenyl phosphate (CDP), TCPP tris(1-chloro-2-propyl)phosphate (TCPP), triethyl phosphate (TEP), Tris(2-chloroethyl) phosphate (TCEP), Diphenyl tolyl phosphate, and Diphenylcresylphosphate (DPK). Alternatively, or additionally, the phosphorus compounds may include one or more of the following phosphonates: inorganic phosphonate, organic phosphonic acid ester, and organic phosphonate. Preferably, the one or more phosphonates are halogen free, e.g., dimethyl propylphosphonate (DMPP), methylphosphonic acid, diethyl ethylphosphonate (DEEP), and dimethyl methylphosphonate (DMMP).

Alternatively, or additionally, the second material may include one or more flame retardant(s) which include at least one amine nitrogen compound, such as at least one of ammonia and its salts, a primary amine, such as monoethanolamine, a secondary amine, a tertiary amine and its salts, derivates of urea and melamine and its salts, melamine cyanurate, and amidinourea and its salts.

Preferably, the flame retardant(s) included in the second material is/are substantially free of halogenides, more preferably free of organic halogenides.

Preferably, the flame retardant(s) included in the second material is/are free of boron, its salts, and compounds.

The reinforcement material(s), which may be provided in the second material, may include one or more flame retardants. Suitable and/or advantageous flame retardants for the reinforcement material(s) include one or more of the following: aluminium hydroxide, Zinc borate, borate, other borate compounds, ammonium monophosphate, ammonium polyphosphate, aluminum hydroxide, ammonium polyphosphate, calcium carbonate, gypsum, calcium sulfate hemihydrate, organic phosphonic acid ester, such as CAS No. 3001-98-7.

Alternatively, or additionally, the flame retardant(s) for the reinforcement material(s) may include at least one phosphorus compound, preferably at least one phosphorus compound and at least one nitrogen compound, most preferably one nitrogen phosphorus compound. The nitrogen phosphorus compound may include one or more of the following: amino phosphate, amino phosphonate, ammonium polyphosphate, ammonium phosphate, organic amino phosphate, even more preferably organic amino phosphonate, such as Diethyl-bis(2-hydroxyethyl), aminomethylphosphonate, salt of amines, urea-derivates with phosphorcontaining acids, and salt of urea derivates with organic phosphonic ester

The phosphorus compound may include one or more of the following phosphates: phosphate, phosphoric acid organic phosphate, e.g., alkyl phosphate oligomer, such as CAS No. 184538-58-7), triethyl ester of phosphoric acid, aromatic phosphate ester, phosphorus polyol, OH-terminated phosphorus polyol, diphenyl phenyl phosphate (DPK), cresyl diphenyl phosphate (CDP), TCPP tris(1-chloro-2-propyl)phosphate (TCPP), triethyl phosphate (TEP), Tris(2-chloroethyl) phosphate (TCEP), Diphenyl tolyl phosphate, and Diphenylcresylphosphate (DPK).

Alternatively, or additionally, the phosphorus compounds may include one or more of the following phosphonates: inorganic phosphonate, organic phosphonic acid ester, and organic phosphonate. Preferably, the one or more phosphonates are halogen free, e.g., dimethyl propylphosphonate (DMPP), methylphosphonic acid, diethyl ethylphosphonate (DEEP), and dimethyl methylphosphonate (DMMP).

Alternatively, or additionally, the one or more flame retardants for the reinforcement material(s), which may be provided in the second material, may include at least one amine nitrogen compound, such as at least one of ammonia and its salts, a primary amine, a secondary amine, a tertiary amine and its salts, derivates of urea and melamine and its salts, melamine cyanurate, and amidinourea and its salts.

Preferably the one or more flame retardant(s) for the for the reinforcement material(s), are substantially free of halogenides, more preferably free of organic halogenides.

Preferably the flame retardant(s) for the reinforcement material(s) are free of boron, its salts, and compounds.

Preferably the flame retardant(s) for the reinforcement material(s) include at least one organic phosphorous compound.

Preferably the first material of the islands includes a one or more binder materials which may include a polymeric material or resin, preferably an organic polymer, more preferably a polyurethan, more preferably a polyester, most preferably an epoxy resin. Surprisingly, the inventors have found that the above-identified binder materials, in liquid form, i.e., before curing/hardening of the first material, using at least one polyester and/or at least one epoxy resin may be applied and spread relatively homogeneously in the method step b). Also, preferably, prior to step b), the first material, in a liquid form, is degassed which may facilitate further handling and/or filling of the mold. The inventors found that, surprisingly, the degassing step is more efficient for first materials which include polyester and/or epoxy resins.

Suitable and advantageous flame retardants for the first material may include one or more of the following: aluminum hydroxide, zinc borate, borate, one or more further borate compounds, ammonium monophosphate, ammonium polyphosphate, aluminum hydroxide, ammonium polyphosphate, calcium carbonate, gypsum, calcium sulfate hemihydrate, organic phosphonic acid ester, such as CAS No. 3001-98-7.

Alternatively, or additionally, the flame retardant(s) for the first material preferably includes at least one phosphorus compound, preferably at least one nitrogen phosphorus compound, most preferably at least one phosphorus compound and at least one nitrogen compound.

The phosphorus compound may include one or more of the following phosphates: phosphate, phosphoric acid organic phosphate, e.g., alkyl phosphate, alkyl phosphate oligomer, such as, CAS No. 184538-58-7, triethyl ester of phosphoric acid, aromatic phosphate ester, phosphorus polyol, OH-terminated phosphorus polyol, diphenyl phenyl phosphate (DPK), cresyl diphenyl phosphate (CDP), TCPP tris(1-chloro-2-propyl)phosphate (TCPP), triethyl phosphate (TEP), Tris(2-chloroethyl) phosphate (TCEP), Tris(1,3-dichlorisopropyl)phosphate, Diphenyl tolyl phosphate, Tricresyl phosphate.

Alternatively, or additionally, the phosphorus compounds may include one or more of the following phosphonates: inorganic phosphonate, organic phosphonic acid ester, and organic phosphonate.

Preferably, the one or more phosphonates are halogen free, e.g., dimethyl propylphosphonate (DMPP), methylphosphonic acid, diethyl ethylphosphonate (DEEP), and dimethyl methylphosphonate (DMMP).

Alternatively, or additionally the flame retardant(s) for the first material includes at least one nitrogen compound, such as at least one of ammonia and its salts, a primary amine, such as monoethanolamine, a secondary amine, a tertiary amine and its salts, derivates of urea and melamine and its salts, melamine cyanurate, and amidinourea and its salts.

The nitrogen phosphorus compound may include one or more of the following: amino phosphate, amino phosphonate, ammonium polyphosphate, ammonium phosphate, organic amino phosphate, even more preferably organic amino phosphonate (e.g. Diethyl-bis(2-hydroxyethyl), aminomethylphosphonate, salt of amines, urea-derivates with phosphorcontaining acids, and salt of urea derivates with organic phosphonic ester.

Preferably, the flame retardant(s) included in the first material is/are substantially free of halogenides, more preferably free of organic halogenides.

Preferably the flame retardant(s) included in the first material is/are free of boron, its salts, and compounds.

### Group A:

Preferably the flame retardant(s) for the first material includes a phosphor-organic compound. Preferably the phosphor-organic compound has a phosphorus content (m/m) of 3-6%. Preferably, the flame retardant for the first material includes 9,10-Dihydro-9-oxa-10-phosphaphenanthren-10-oxid (DOPO) or a compound derived from DOPO. Preferably, the flame retardant(s) for the first material includes an epoxy resin modified with DOPO (commercially available for instance as STRUKTOL POLYPHLOX® 3742, STRUKTOL® POLYPHLOX® 3743, STRUKTOL® POLYPHLOX® 3775 LV, STRUKTOL® POLYPHLOX® 3722). Preferably, the flame retardant(s) for the first material includes a hydroxy functional phosphoric compound that can chemically react and covalently bond to a potential resin content in the first material, e.g., STRUKTOL® POLYPHLOX® 3700. Preferably, the flame retardant for the first material includes an ammonium-polyphosphate modified resin, e.g., STRUKTOL POLYPHLOX 3721. Preferably, the flame retardant for the first material includes an organic phosphonate, e.g., Diethyl ethylphosphonate.

If the first material includes a binder which is an epoxy resin, the flame retardant for the first material preferably includes at least one compound of group A.

If the first material includes a binder which is an epoxy resin, a polyester or a polyurethan, the flame retardant for the first material preferably includes at least one compound of group A.

Preferably the flame retardant concentration in the first material is at least 5 wt %, more preferably at least 7 wt %, more preferably at least 8 wt %, more preferably at least 10 wt % of a total weight of the first material. Preferably, the flame retardant concentration in the first material is preferably less than 90 wt %, more preferably less than 60 wt %, more preferably less than 50 wt %, more preferably less than 40 wt %, more preferably less than 30 wt %, more preferably less than 20 wt % of a total weight of the first material, e.g., in order to prevent or at least limit a deterioration of one or more properties, e.g., processing parameters, of the first material, which may be caused by the flame retardant(s), and/or to retain a favorable and/or aesthetically pleasing appearance of the decorative article, in particular the first material, to the user(s).

Preferably the flame retardant concentration in the second material is at least 3 wt %, more preferably at least 5 wt %, more preferably at least 10 wt %, more preferably at least 20 wt %, more preferably at least 30 wt % of a total weight of the second material. Preferably, the flame retardant amounts to less than 90 wt %, more preferably less than 80 wt %, more preferably less than 70 wt %, more preferably less than 60 wt %, more preferably less than 50 wt %, most preferably less than 40 wt % of a total weight of the second material, e.g., in order to prevent or at least limit a deterioration of one or more properties, e.g., processing parameters, of the second material, which may be caused by the flame retardant(s), and/or to retain a relatively high degree of bending and/or elastic properties of the second material.

Preferably, the flame retardant(s) included in one or more reinforcement materials, e.g., one or more webs, fibers and/or textiles, of the second material accounts for 1.5 wt % to 30.0 wt %, preferably 1.5 wt % to 25.0 wt %, more preferably 1.5 wt % to 20.0 wt %, more preferably 1.5 wt % to 15.0 wt %, more preferably 2 wt % to 10.0 wt %, more preferably 2.5 wt % to 7 wt %, more preferably 3.0 wt % to 8 wt %, more preferably 3.0 wt % to 8.0 wt %, most preferably 4.0 wt % to 7.0 wt %, of a total weight of the reinforcement material(s).

Preferably, a polymer/resin of the first material accounts for 10 wt % to 60 wt %, more preferably 15 wt % to 55 wt %, more preferably 20 wt % to 50 wt %, most preferably 20 wt % to 45 wt % of a total weight of the first material.

Preferably, the first material includes at least one pigment and/or at least one dye, e.g., to change the color and/or optics of the first material.

Preferably, the second material includes at least one pigment or at least one dye, e.g., to change the color or optics of the second material. This may be particularly advantageous, if the first material is configured to be at least partially opaque, e.g., by using higher quantities of mother of pearl, since the second material will then be at least partially visible through the first material which may add to the aesthetic appeal of the decorative article and/or may add optical depth to the decorative article.

Preferably, the inorganic compounds of the first material includes at least one upcycled material and/or at least one recycled material, wherein the sum of the upcycled material(s) and/or at least one recycled material(s) amounts to at least 10 wt %, more preferably at least 20 wt %, more preferably at least 30 wt %, more preferably at least 40 wt %, more preferably at least 50 wt %, more preferably at least 60 wt %, more preferably at least 70 wt %, more preferably at least 80 wt %, more preferably at least 90 wt %, more preferably at least 95 wt % of a total weight of the inorganic compounds.

Preferably, the first material is at least one of the following: a metal, preferably a polymer-metal composite, a composite material including rock flour dispersed in one or more polymers, a composite material including metal powder or particles dispersed in one or more polymers.

Preferably, in step (b), the recesses are completely filled with the first material.

Preferably, in step (d), the second material has a viscosity which is less than 25,000 mPa*s, preferably less than 20,000 mPa*s, more preferably less than 15,000 mPa*s. The viscosity is thus determined before curing of the second material, which is optional.

Preferably, the first material includes at least one type of metal, preferably in particle and/or fiber form, preferably wherein the metal is dispersed in an epoxy resin.

The following list of aspects provides alternative and/or further features of the invention:

1. Decorative article for decoratively covering at least a portion of one or more objects, including:
a plurality of islands, preferably discrete islands, made of at least one first material; and
at least one base layer made of at least one second material;
wherein the base layer is preferably substantially flexible; and
wherein the islands are attached to at least a first base layer surface of the base layer at positions, preferably discrete positions, on the first base layer surface such that the decorative article is flexible, preferably at least in regions between the islands.

2. Decorative article according to aspect 1, wherein the base layer has a greater flexibility, preferably a greater elastic stretchability, than the islands.

3. Decorative article according to aspect 1 or 2, wherein the islands are arranged in at least one pattern, preferably at least one repeating pattern, in at least a section of the first base layer surface of the base layer.

4. Decorative article according to any of the preceding aspects, wherein the islands are arranged irregularly in at least a section of the first base layer surface of the base layer.

5. Decorative article according to any of the preceding aspects, wherein the islands are shaped and/or dimensioned and/or distributed on the base layer and/or distanced from each other in a manner to control flexing and/or bending and/or stretching of the decorative article in at least one or more sections thereof.

6. Decorative article according to any of the preceding aspects, wherein the islands are shaped and/or dimensioned and/or distributed on the base layer in a manner to vary one or more flexing characteristics and/or bending characteristics and/or stretching characteristics of the decorative article across the decorative article.

7. Decorative article according to any of the preceding aspects, wherein, preferably based on a manner in which the islands are shaped and/or dimensioned and/or distributed on the base layer, at least one first section of the decorative article is configured to flex and/or bend and/or stretch:
to a greater extent than at least one second section of the decorative article;
and/or
more easily in at least one first direction than in at least one second direction, and preferably wherein at least one second section of the decorative article is configured to flex and/or bend and/or stretch more easily in at least one direction, which is different from the first direction, than the first direction.

8. Decorative article according to any of the preceding aspects, wherein the islands are shaped and/or dimensioned and/or distributed on the base layer and/or distanced from each other in a manner to:
facilitate a conformability of the decorative article to at least one contour of the one or more objects, at least a portion of which is to be decoratively covered by the decorative article;
and/or
substantially conform to at least one shape and/or one or more dimensions of the one or more objects, at least a portion of which is to be decoratively covered by the decorative article, wherein the one or more objects are configured such that the at least one shape and/or one or more dimensions can be altered, in a state in which the one or more objects are at least partially covered by the decorative article.

9. Decorative article according to any of the preceding aspects, wherein the decorative article is configured to cover at least a portion of one or more objects which are configured to be arranged in an aircraft.

10. Decorative article according to any of the preceding aspects, wherein the decorative article is configured for use in powered aircraft travel.

11. Decorative article according to any of the preceding aspects, wherein the decorative article is configured to pass the vertical burn test.

12. Decorative article according to any of the preceding aspects, wherein the base layer is elastically stretchable in at least two dimensions, which preferably lie in a single plane, when the base layer is arranged in or along the plane.

13. Decorative article according to any of the preceding aspects, wherein the decorative article is at least partially made by means of one or more casting processes.

14. Decorative article according to any of the preceding aspects, wherein the islands are configured and arranged on the first base layer surface such that the decorative article, matches or at least resembles, at least optically, a structure of a natural material, preferably an animal skin.

15. Decorative article according to any of the preceding aspects, wherein the second material includes at least one of the following: a polymeric material, preferably an elastomer, a fleece material, preferably including at least one flame retardant substance, a textile material, a fiber composite material which is preferably embedded in an elastomer and preferably includes glass fibers.

16. Decorative article according to any of the preceding aspects, wherein the base layer and/or the islands include(s) at least one flame retardant substance.

17. Decorative article according to any of the preceding aspects, wherein the first material includes at least one of the following: a metal, preferably a polymer-metal composite, a rock flour, preferably a composite material including rock flour dispersed in one or more polymers.

18. Decorative article according to any of the preceding aspects, wherein the first material includes at least one type of metal, preferably in particle and/or fiber form, preferably wherein the metal is dispersed in an epoxy resin.

19. Decorative article according to any of the preceding aspects, wherein at least some of the islands have at least one surface which has been treated by means of at least one treatment process to alter one or more characteristics, preferably one or more optical characteristics, of the surface.

20. Decorative article according to any of the preceding aspects, wherein at least some of the islands have at least one polished surface and/or sanded surface, preferably at least one polished surface and/or sanded surface which faces away from the base layer and/or which is arranged on a side of the islands which is opposite from the base layer.

21. Decorative article according to any of the preceding aspects, wherein at least some of the islands have at least one surface, preferably a surface which faces away from the base layer and/or which is arranged on a side of the islands which is opposite from the base layer, which has a glossy finish and/or a polished finish and/or a sanded finish and/or a light reflective finish and/or a shiny finish.

22. Decorative article according to any of the preceding aspects, further including at least one coating which is provided on at least one surface of at least some of the islands, preferably a surface of the islands which faces away from the base layer and/or which is arranged on a side of the islands which is opposite from the base layer, and/or on at least a section of the base layer.

23. Decorative article according to aspect 22, wherein the coating provides at least one of the following effects: increases the light reflective properties of the surface/section, alters the color of the surface/section, protects the surface/section, seals the surface/section, hardens the surface/section, alters one or more haptic properties of the surface/section, and increases a bonding strength between the islands and the base layer.

24. Decorative article according to any of the preceding aspects, wherein the decorative article is configured to decoratively cover at least a portion of one or more objects whose shape and/or dimensions may be altered, in a state in which the one or more objects are at least partially covered by the decorative article, wherein the decorative article is configured to substantially conform to the altered shape and/or the altered dimensions of the one or more objects.

25. Decorative article according to aspect 24, wherein the shape and/or dimensions of the one or more objects may be altered by flexing and/or bending and/or stretching the one or more objects.

26. Decorative article according to any of the preceding aspects, wherein the decorative article has an elongation at break in at least one dimension, preferably at least two dimensions, which preferably lie in a single plane, when the base layer is arranged in the plane, of up to 70%, more preferably up to 60%, more preferably up to 50%, more preferably up to 45%, more preferably up to 40%, more preferably up to 35%, more preferably up to 30%, more preferably up to 25%, more preferably up to 20%, more preferably up to 15%, more preferably between 5% and 15%, most preferably between 7% and 12%.

27. Decorative article according to any of the preceding aspects, wherein the islands are attached to the base layer at respective interface surfaces, and wherein the islands are configured and arranged to substantially prevent the base layer from stretching at the respective interface surfaces.

28. Decorative article according to any of the preceding aspects, wherein the decorative article is configured such that the decorative article is stretchable only in regions of the decorative article which are arranged at least partially between the islands.

29. Decorative article according to any of the preceding aspects, wherein the decorative article has a tensile strength of at least 10 N/mm2, preferably at least 15 N/mm2, more preferably at least 20 N/mm2, most preferably at least 25 N/mm2 in at least one dimension in which the decorative article is elastically stretchable.

30. Decorative article according to any of the preceding aspects, wherein the second material includes one or more reinforcement materials of the following: a fleece material, a glass fleece, a fiber composite, a textile material, and a web.

31. Decorative article according to any of the preceding aspects, wherein the islands are configured as projections which extend from the first base layer surface of the base layer.

32. Decorative article according to aspect 31, wherein each projection is tapered in a direction in which the projections extend from the first base layer surface of the base layer.

33. Decorative article according to aspect 31 or 32, wherein each projection has at least one flank, which extends from the first base layer surface of the base layer, wherein the flank forms an angle with a section of the first base layer surface, the projection being attached to said section, which is less than 90°, preferably less than 85°, and preferably greater than 75°.

34. Decorative article according to any of aspects 31 to 33, wherein each projection has a base surface, at which the projection is attached to the first base layer surface of the base layer, which has a total area from 1 mm² to 500 mm², preferably from 1 mm² to 400 mm², more preferably from 1 mm² to 350 mm², more preferably from 1 mm² to 300 mm², more preferably from 1 mm² to 250 mm², more preferably from 1 mm² to 200 mm², more preferably from 1 mm² to 150 mm², more preferably from 1 mm² to 100 mm², more preferably from 1 mm² to 90 mm², more preferably from 1 mm² to 80 mm², more preferably from 1 mm² to 70 mm², more preferably from 1 mm² to 60 mm², more preferably from 1 mm² to 50 mm², more preferably from 1 mm² to 40 mm², more preferably from 1 mm² to 30 mm², more preferably from 1 mm² to 20 mm², more preferably from 2 mm² to 20 mm², more preferably from 3 mm² to 20 mm², most preferably from 4 mm² to 20 mm².

35. Decorative article according to any of aspects 31 to 34, wherein each projection has a height, in a direction in which the projections extend from the first base layer surface of the base layer and/or in a direction which extends substantially perpendicularly to the first base layer surface, from 0.1 mm to 3 mm, more preferably from 0.15 mm to 3 mm, more preferably from 0.2 mm to 3 mm, more preferably from 0.25 mm to 3 mm, more preferably from 0.25 mm to 2.7 mm, more preferably from 0.3 mm to 2.6 mm, more preferably from 0.35 mm to 2.6 mm, more preferably from 0.4 mm to 2.5 mm, more preferably from 0.45 mm to 2.4 mm, more preferably from 0.5 mm to 2.3 mm, more preferably from 0.55 mm to 2.2 mm, more preferably from 0.6 mm to 2.1 mm, more preferably from 0.65 mm to 2 mm, most preferably from 1 mm to 2 mm.

36. Decorative article according to any of aspects 31 to 35, wherein each projection has one or more rounded edges at one or more sections of the projections, preferably at a distal section of the projection.

37. Decorative article according to aspect 36, wherein one or more of the rounded edges of each projection have a radius which is greater than 0.05 mm, more preferably greater than 0.1 mm.

38. Decorative article according to any of aspects 31 to 37, wherein each projection has a top face, which is arranged on a side of the projection which is opposite from the first base layer surface of the base layer and/or which extends substantially parallel to the first base layer surface of the base layer, wherein the top face defines a surface which lies substantially in a single plane, wherein the plane extends substantially parallel to the first base layer surface of the base layer.

39. Decorative article according to any of aspects 31 to 38, wherein the projections have an average width from 0.5 mm to 5 mm, preferably from 0.5 mm to 4.8 mm, more preferably from 0.5 mm to 4.6 mm, more preferably from 0.5 mm to 4.4 mm, more preferably from 0.5 mm to 4.2 mm, more preferably from 0.5 mm to 4 mm, more preferably from 0.5 mm to 3.8 mm, more preferably from 0.5 mm to 3.6 mm, more preferably from 0.5 mm to 3.4 mm, more preferably from 0.5 mm to 3.2 mm, more preferably from 0.5 mm to 3 mm, more preferably from 0.5 mm to 2.8 mm, more preferably from 0.5 mm to 2.6 mm, more preferably from 0.5 mm to 2.4 mm, more preferably from 0.6 mm to 2.4 mm, more preferably from 0.7 mm to 2.4 mm, more preferably from 0.8 mm to 2.3 mm, more preferably from 0.9 mm to 2.1 mm, more preferably from 0.9 mm to 2 mm, most preferably from 1 mm to 2 mm.

40. Decorative article according to any of the preceding aspects, wherein adjacent islands are spaced from each other by a distance from 0.2 mm to 5 mm, preferably from 0.5 mm to 5 mm, more preferably from 0.5 mm to 4 mm, more preferably from 0.5 mm to 3.5 mm, more preferably from 0.5 mm to 3 mm, more preferably from 0.5 mm to 2.5 mm, most preferably from 0.5 mm to 1.5 mm.

41. Decorative article according to any of the preceding aspects, wherein the base layer has a thickness which is at least 0.1 mm, preferably at least 0.2 mm, more preferably from 0.2 mm to 2 mm, more preferably from 0.2 mm to 1.5 mm, more preferably from 0.2 mm to 1 mm, most preferably from 0.3 mm to 0.8 mm.

42. Decorative article according to any of the preceding aspects, wherein the decorative article includes intermediate regions which are arranged substantially between adjacent islands, where the intermediate regions are interconnected, preferably across the entire decorative article, preferably in a web-like manner.

43. An object, preferably a piece of furniture or a wall element, the object preferably being configured to be arranged in an interior of a vehicle, preferably an aircraft or a watercraft, wherein the object is at least partially covered by a decorative article according to any of the preceding aspects.

44. A vehicle, preferably an aircraft or a watercraft, having an interior in which one or more objects, preferably an object according to aspect 43, which are at least partially covered by a decorative article according to any of aspects 1 to 42, are arranged.

45. Method for manufacturing a decorative article configured to decoratively cover at least a portion of one or more objects, preferably for manufacturing a decorative article according to any of aspects 1 to 42, including the steps of:
(a) providing a mold having a plurality of recesses which are preferably separated from each other by one or more walls;
(b) applying at least one first material to the mold such that at least a portion of the respective recesses is filled with a deposit of first material;
(c) optionally, removing excess first material which is arranged outside of the recesses, if said excess first material is present;
(d) applying at least one second material to the mold to provide a base layer, which is substantially flexible and on which the deposits of the first material are attached; and
(e) removing the first material and the second material from the mold;
   wherein a decorative article including the base layer and a plurality of islands, preferably discrete islands, made of the first material attached to a first base layer surface at positions, preferably discrete positions, on the first base layer surface is provided, and wherein the decorative article is elastically stretchable, preferably at least in regions of the base layer which are arranged at least partially between the islands.

46. Method according to aspect 45, wherein at least prior to step (e), the first material and/or the second material is/are cured in one or more curing steps.

47. Method according to aspect 45 or 46, wherein at least one surface of at least some of the islands, preferably at least one surface which faces away from the base layer and/or which is arranged on a side of the islands which is opposite from the base layer, and/or at least one surface of the base layer is/are treated in one or more treatments steps to alter one or more characteristics, preferably one or more optical characteristics, of the respective surface.

48. Method according to any of aspects 45 to 47, wherein at least one surface of at least some of the islands, preferably at least one surface which faces away from the base layer and/or which is arranged on a side of the islands which is opposite from the base layer, and/or at least one surface of the base layer is/are treated by polishing and/or sanding and/or coating the respective surface.

49. Method according to any of aspects 45 to 48, wherein a flame retardant is added to at least one of the following: the first material, the second material, the base layer, the base layer first surface, and the islands.

50. Method according to any of aspects 45 to 49, wherein the mold is at least partially made of silicone.

51. Method according to any of aspects 45 to 50, wherein the recesses are configured and arranged to shape and/or arrange the islands on the first base layer surface such that the decorative article matches or at least resembles, at least optically, a structure of a natural material, preferably an animal skin

52. Method according to any of aspects 45 to 51, wherein the second material includes at least one of the following: a polymeric material, preferably an elastomer, a fleece material, preferably including at least one flame retardant substance, a textile material, a fiber composite material which is preferably embedded in an elastomer and preferably includes glass fibers.

53. Method according to any of aspects 45 to 52, wherein the first material is at least one of the following: a metal, preferably a polymer-metal composite, a rock flour, preferably a composite material including rock flour dispersed in one or more polymers.

54. Method according to any of aspects 45 to 53, wherein, in step (b), the recesses are completely filled with the first material.

55. Method according to any of aspects 45 to 54, wherein, in step (d), the second material has a viscosity which is less than 25000 mPa*s, preferably less than 20000 mPa*s, more preferably less than 15.000 mPa*s.

56. Method according to any of aspects 45 to 55, wherein the first material includes at least one type of metal, preferably in particle and/or fiber form, preferably wherein the metal is dispersed in an epoxy resin.

### BRIEF DESCRIPTION OF THE DRAWINGS

FIG. 1 shows, in a schematic and perspective view, a decorative article according to an embodiment of the present invention;

FIG. 2 shows, in a schematic and perspective view, a decorative article according to a further embodiment of the present invention;

FIG. 3 shows, in a schematic and perspective view, a decorative article according to a further embodiment of the present invention;

FIG. 4 shows, in a schematic and perspective view, a decorative article according to a further embodiment of the present invention;

FIG. 5 shows an enlarged view of a section of the decorative article shown in FIG. 4;

FIG. 6 shows, in a schematic and perspective view, a decorative article according to a further embodiment of the present invention;

FIG. 7 shows, in a schematic and perspective view, steps of a method for manufacturing the decorative articles shown in FIGS. 1 to 6;

FIG. 8 shows, in a schematic and perspective view, further steps of a method for manufacturing the decorative articles shown in FIGS. 1 to 6;

FIG. 9 shows, in a schematic and perspective view, a variation of the decorative article manufactured by the method shown in FIGS. 7 and 8;

FIG. 10 shows, in a schematic and perspective view, a further variation of the decorative article manufactured by the method shown in FIGS. 7 and 8;

FIG. 11 shows, in a schematic and perspective view, an enlarged view of an island of the decorative article according to an embodiment of the present invention.

### DETAILED DESCRIPTION

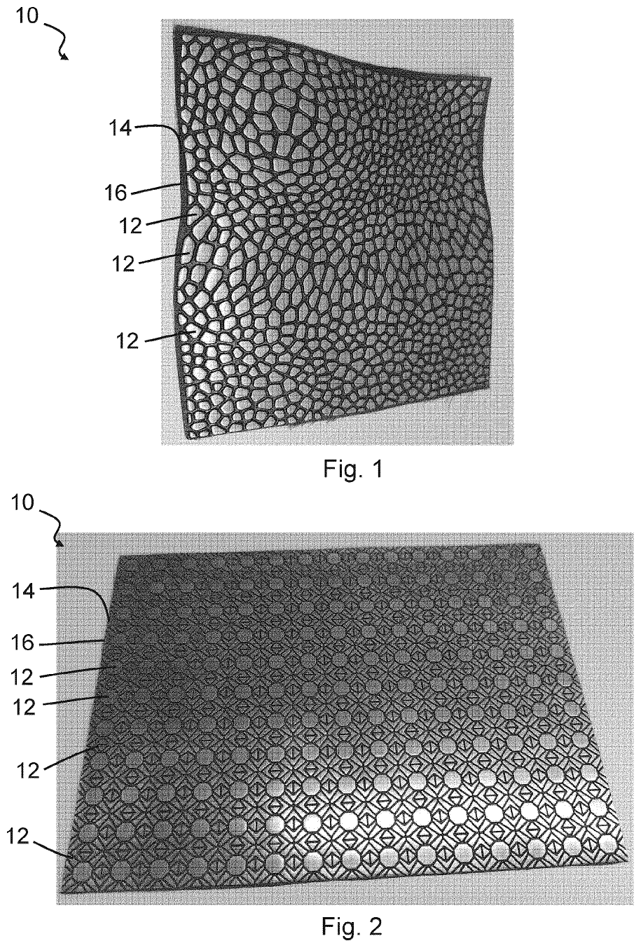

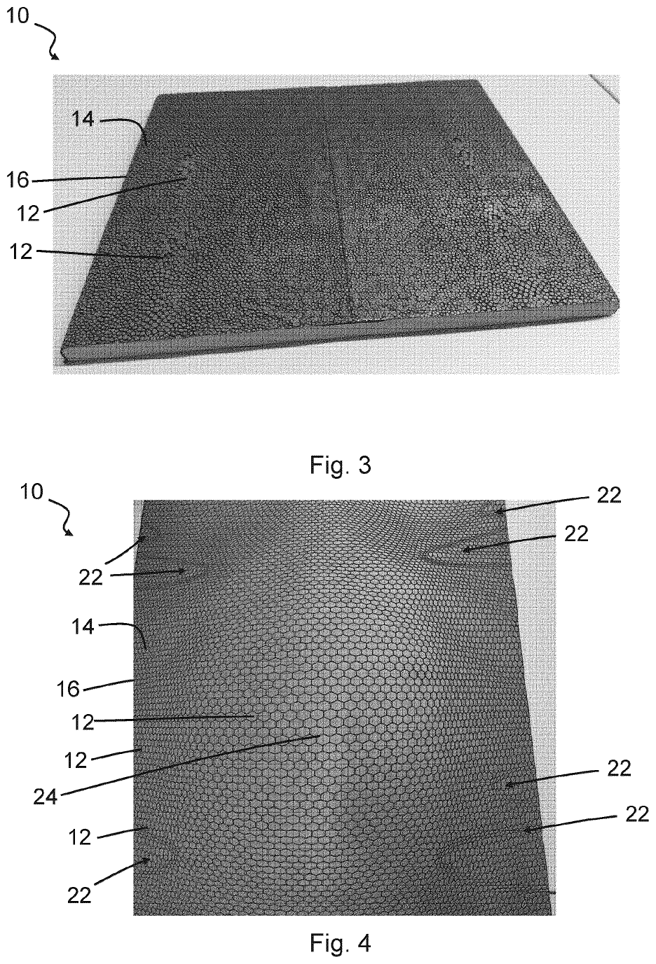

FIGS. 1 to 6 show, in schematic and perspective views, various embodiments of a decorative article 10 for decoratively covering at least a portion of one or more objects. In each embodiment of FIGS. 1 to 6, the decorative article 10 includes a plurality of discrete islands 12 which are attached to a first base layer surface 14 of a substantially flexible base layer 16. In particular, the islands 12 are attached at discrete positions on the first base layer surface 14 such that the decorative article 10 is flexible at least in regions between the islands 12. The islands 12 may be connected adhesively/cohesively to the base layer 16, e.g., via interaction of the first material and the second material. An additional adhesive substance may also be employed to attach, or at least aid in attaching, the islands 12 on the base layer 16.

For providing a decorative effect and/or an aesthetically appealing appearance, the islands 12 may be arranged in at least one particular pattern, preferably at least one repeating pattern, in at least a section of the first base layer surface 14 of the base layer 16. Alternatively, the islands 12 may be arranged irregularly, i.e., in a non-patterned manner, in at least a section of the first base layer surface 14 of the base layer 16.

Alternatively, or additionally, the islands 12 may be shaped to provide a particular appearance and/or expression, such as an association, e.g., to a particular company. For instance, one or more of the islands 12 may be shaped in a logo of a company, e.g., a logo of an airline company operating an aircraft in which the decorative article 10 is arranged.

The islands 12 may be made of at least one first material, e.g., a metal. The base layer 16 may be made of at least one second material, e.g., a polymeric material, preferably an elastomer. The second material and the first material may be considered to provide the base material for the base layer 16 and the islands 12, respectively. The islands 12 and/or the base layer 16 may include one or more additive substances, i.e., in addition to the first material and the second material, to alter one or more properties thereof. For instance, the base layer 16 and/or the islands 12 may include at least one flame retardant substance. The decorative article 10 may be configured for use in powered aircraft travel and/or may be configured to pass the vertical burn test. Thus, including at least one flame retardant substance in the base layer 16 and/or the islands 12 may increase the compatibility of the decorative article 10 for such purposes/applications.

As described above, the base layer 16 is configured to be substantially flexible. Thus, the base layer 16 is deformable, e.g., bendable, stretchable, and/or any other form of form of deforming. The islands 12 may also be flexible/deformable. Alternatively, the islands 12 may be substantially rigid, i.e., non-flexible. In case the islands 12 are substantially rigid, i.e., non-flexible, the islands 12 may prevent, or at least limit, flexing/deforming, in particular stretching, of the decorative article 10 along an interface at which the islands 12 are attached to the base layer 16.

The islands 12 may be shaped and/or dimensioned and/or distributed on the base layer 16 and/or distanced from each other in a manner to control flexing and/or bending and/or stretching of the decorative article 10. For instance, the decorative article 10 may be configured to vary in flexibility in at least sections thereof. Thus, the decorative article 10 may have one or more first sections which have a greater flexibility than one or more second sections of the decorative article 10.

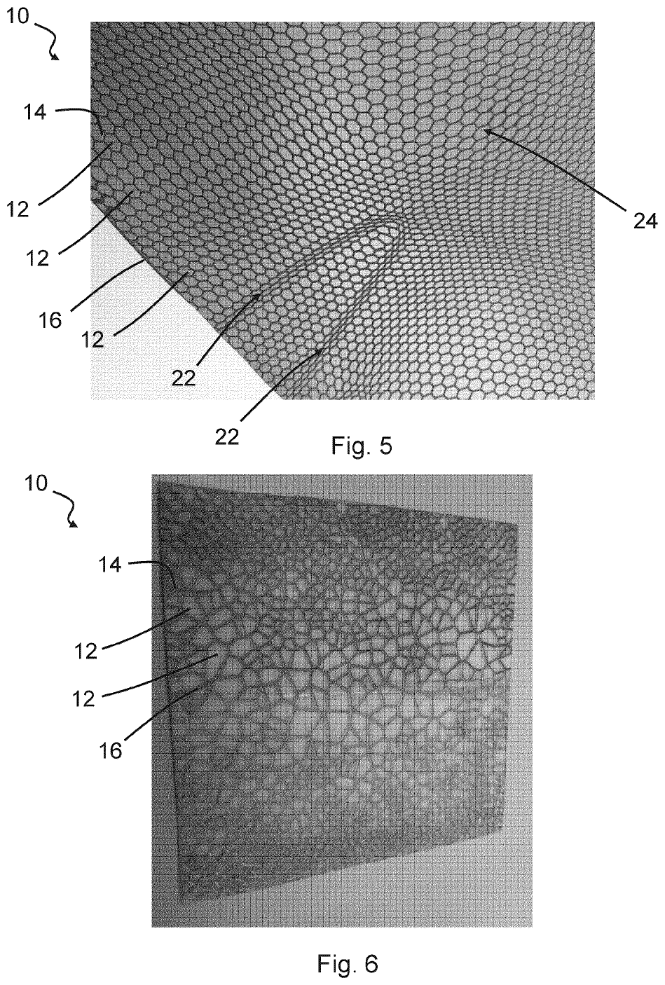

Such a variability in flexibility along at least sections of the decorative article 10 may be based on a manner in which the islands 12 are shaped and/or dimensioned and/or distributed on the base layer 16. For instance, the decorative article 10 may include at least one first section 22 which is configured to flex and/or bend and/or stretch to a greater extent than at least one second section 24 of the decorative article 10 and/or more easily in at least one first direction than in at least one second direction (see FIGS. 4 and 5). As can be seen particularly well in FIG. 5, the islands 12 are shaped and dimensioned in the first section 22 differently than in the second section 24 to achieve one or more of the above-identified effects.

For instance, this may allow the decorative article 10 to flex and/or bend and/or stretch differently, e.g., to a different extent and/or more easily in a certain direction, at or along the first section 22 than at or along the second section 24 of the decorative article 10. This may further improve the adaptability and/or conformability of the decorative article 10, e.g., for covering an object with different contours, e.g., varying bends and/or radii. This may also facilitate the process of covering the object with the decorative article 10.

The material(s) of the islands 12 may be chosen from a wide range of various materials, e.g., metal or, as shown in FIG. 6, rock flour and mother of pearl. The first material of the islands in FIG. 6 contains 35 wt % marble powder and 5 wt % mother of pearl powder, both with d50 grain sizes of 110 μm. Moreover, as shown in FIG. 6, at least the base layer 16 may been colored, e.g., painted. As shown in FIG. 6, a gold colorant, e.g., a gold pigment dispersed in a flexible polyurethan varnish, has been applied to a first section, i.e., an upper section, of the decorative article 10 and a silver colorant, e.g., a silver pigment dispersed in a flexible polyurethan varnish, has been applied to a second section, i.e., a lower section, of the decorative article 10. Moreover, the islands 12 shown in FIG. 6 have been treated, e.g., polished. To achieve the configuration shown in FIG. 6, in which the base layer, at least in sections thereof between the islands, includes a colorant, e.g., dye, an entire surface, or at least a section covering multiple islands 12, which is visible to one or more users in a mounted state of the decorative article 10, of the decorative article 10 may be treated with said colorant, e.g., by painting the entire surface of the decorative article 10, or at least a section covering multiple islands 12, with a colorant, e.g., a dye or a pigment. Then, a section, e.g., an upper section, of the islands 12 may be abrasively treated, e.g., polished, which removes the colorant at least partially from the polished section of the islands 12, e.g., to substantially restore the original/intrinsic appearance of the material of the base layer 16.

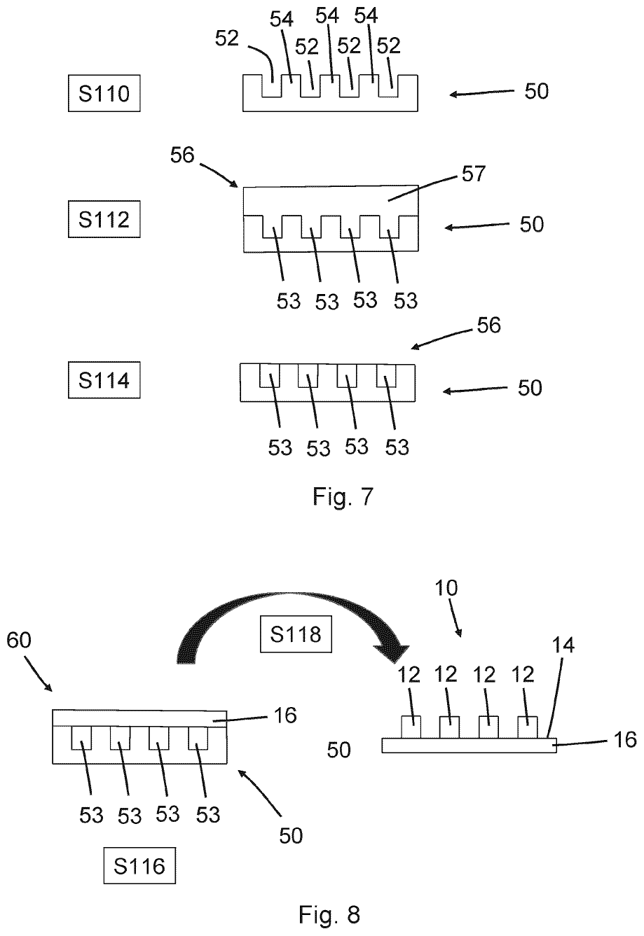

FIGS. 7 and 8 illustrate steps of a method for manufacturing the decorative article 10. The method includes the step of providing a mold 50 having a plurality of recesses 52 which are separated from each other by walls 54, as indicated by step S110 in FIG. 7. The mold 50 may be at least partially, preferably completely, made of silicone. The recesses 52 may be configured and arranged, e.g., shaped, distributed and/or sized, according to a desired pattern and/or arrangement of the islands 12 on the first base layer surface 14. For instance, the recesses 52 may be shaped, distributed and/or sized such that the resulting decorative article 10 matches or at least resembles, at least optically, a structure of a natural material, preferably an animal skin.

The method further includes the step of applying at least one first material 56 to the mold 50 such that at least a portion of the respective recesses 52 is filled with a deposit 53 of the first material 56, as indicated by step S112 in FIG. 7. The first material 56 may be selected from a variety of feasible materials, e.g., a metal, preferably a polymer-metal composite, and/or a rock flour, preferably a composite material including rock flour dispersed in one or more polymers. Preferably, the recesses 52 are completely filled with the first material 56. The first material 56 may be provided in any form, preferably in particle and/or fiber form, preferably wherein the metal is dispersed in an epoxy resin.

Next, an excess portion 57 of the first material 56 arranged outside of the recesses 52, is removed, if such excess portion 57 is present (see step S114 in FIG. 7).

The method further includes the step of applying at least one second material 60 to the mold 50 to provide the base layer 16, which is substantially flexible and on which the deposits 53 of the first material 56 are attached (see step S116 in FIG. 8). The second material 60 may be selected from a variety of feasible materials, e.g., a polymeric material, preferably an elastomer. The second material 60 is applied to the mold 50 such that the resulting base layer 16 is attached to and interconnects a plurality of islands 12 on and along the first base layer surface 14. Thus, preferably, the second material 60 is applied to the mold 50 such that the resulting base layer 16 is continuous, i.e., a continuous sheet or strip of the second material 60.

The first material 56 and the second material 60 are removed from the mold 50 in step S118 (see FIG. 8).

The above-described method results in a decorative article 10 including the base layer 16 and the plurality of discrete islands 12 made of the first material 56 attached to the first base layer surface 14 of the base layer 16 at discrete positions on the first base layer surface 14. The decorative article 10 is elastically stretchable in regions of the base layer 16 which are arranged at least partially between the islands 12.

Optionally, the first material 56 and/or the second material 60 may be cured in one or more curing steps, preferably prior to at least step S118, i.e., before the first material 56 and the second material 60 are removed from the mold 50.

A flame retardant may be added to the first material 56, the second material 60, the base layer 16, the base layer first surface 14, and/or the islands 12. For instance, the flame retardant may be mixed with the first material 56, the second material 60 and/or another material included in the decorative article 10, preferably prior to at least step S112, if the flame retardant is mixed with the first material 56, and/or preferably prior to step S116, if the flame retardant is mixed with the second material 60.

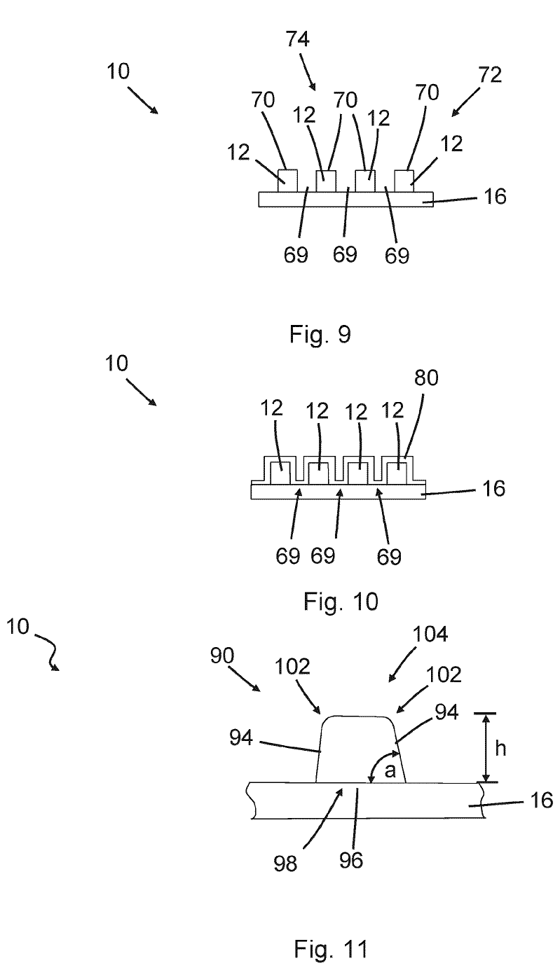

The decorative article 10 includes intermediate regions 69 which are arranged substantially between adjacent islands 12. The intermediate regions 69 may be interconnected, preferably across the entire decorative article 10, preferably in a web-like manner. The intermediate regions 69 may include a void or empty space, as shown in FIGS. 8 and 9, and/or a material, e.g., a coating arranged, as shown in FIG. 10 and discussed further below, substantially between the islands 12.

Further optionally, at least one surface of at least some of the islands 12 may be treated in one or more treatments steps to alter one or more characteristics, preferably one or more optical characteristics, of the respective surface. Alternatively, or additionally, at least one surface of the base layer 56 and/or at least one surface of the islands 12 may be treated by polishing and/or sanding and/or coating the respective surface. For instance, FIG. 9 shows, in a schematic and perspective view, a variation of the decorative article 10 manufactured by the method described herein. In particular, the islands 12 of the decorative article 10 according to the embodiment shown in FIG. 9 have been treated on a surface 70 thereof arranged on a top face 72 of each island 12. In particular, the surface 70 may be polished, sanded, coated or treated in any other manner to alter one or more characteristics, preferably one or more optical characteristics, of the surface 70. As can be seen in FIG. 9, the surface 70 faces away from the base layer 16 and is arranged on a side 74 of the islands 12 which is opposite from the base layer 16.

FIG. 10 shows, in a schematic and perspective view, a further variation of the decorative article 10 in which a coating 80 on the base layer 16 and the islands 12. The coating 80 shown in FIG. 10 extends continuously across at least a section of each of the islands 12 and the base layer. Alternatively, only the islands 12, in particular at least a section of the islands 12, e.g., the surface 70 shown in FIG. 9, may be coated by the coating 80. Further alternatively, only the base layer 16, in particular at least a section of the base layer 16 may be coated by the coating 80. The later may be achieved for instance by choosing both islands and baselayer with the coating and then mechanically polishing the island thereby completely removing to coating from the top surface of the islands.

FIG. 11 shows, in a schematic and perspective view, an enlarged view of an island 12 of the decorative article 10 according to an embodiment of the present invention. As can be seen in FIGS. 8 to 10, the islands 12 may be configured as projections 90 which extend from the first base layer surface 14 of the base layer 16. An exemplary projection 90, i.e., an island 12, is shown in FIG. 11. The configuration of the projection shown in FIG. 11 is applicable to at least a plurality, preferably all, of the islands 12 of the decorative article 10.

The projection 90 is tapered in a direction in which the projections 90 extend from the first base layer surface 14 of the base layer 16.

The projection 90 has at least one flank 94, which extends from the first base layer surface 14 of the base layer 16. The flank 94 forms an angle α with a section 96 of the first base layer surface 14, the projection 90 being attached to said section 96, which is less than 90°, preferably less than 85%, and preferably greater than 75°. In particular, the projection 90 has a base surface 98 which is attached to the first base layer surface 14 of the base layer 16.

The projection 90 has a height h, in a direction in which the projections 90 extend from the first base layer surface 14 of the base layer 16, of preferably 0.1 mm to 3 mm.

Moreover, the projection 90 has one or more rounded edges 102 at a distal section 104 of the projection 90.

1. Decorative article for decoratively covering at least a portion of one or more objects, including:
a plurality of discrete islands made of at least one first material;
at least one base layer made of at least one second material;
wherein the base layer is substantially flexible; and
wherein the islands are attached to at least a first base layer surface of the base layer at discrete positions on the first base layer surface such that the decorative article is flexible in regions between the islands.

2. Decorative article according to claim 1, wherein the base layer has a greater flexibility than the discrete islands.

3. Decorative article according to claim 1, wherein the islands are arranged in at least one pattern in at least a section of the first base layer surface of the base layer.

4. Decorative article according to claim 1, wherein the islands are arranged irregularly in at least a section of the first base layer surface of the base layer.

5. Decorative article according to claim 1, wherein the islands are at least one of shaped or dimensioned or distributed on the base layer or distanced from each other in a manner to control at least one of flexing or bending or stretching of the decorative article in at least one or more sections thereof.

6. Decorative article according to claim 1, wherein the islands are at least one of shaped or dimensioned or distributed on the base layer in a manner to vary at least one of one or more flexing characteristics or one or more bending characteristics or one or more stretching characteristics of the decorative article across the decorative article.

7. Decorative article according to claim 1, wherein at least one first section of the decorative article is configured to at least one flex or bend or stretch in at least one of the following manners:
to a greater extent than at least one second section of the decorative article; or
more easily in at least one first direction than in at least one second direction.

8. Decorative article according to claim 1, wherein the decorative article is configured to pass the vertical burn test.

9. Decorative article according to claim 1, wherein the base layer is elastically stretchable in at least two dimensions, when the base layer is arranged in or along the plane.

10. Decorative article according to claim 1, wherein the second material includes at least one of the following: a polymeric material, a fleece material, a textile material, a fiber composite material.

11. Decorative article according to claim 1, wherein at least one of the base layer or the islands include(s) at least one flame retardant substance.

12. Decorative article according to claim 1, wherein the first material includes at least one of the following: a metal, a polymer-metal composite, a rock flour, or a composite material including rock flour dispersed in one or more polymers.

13. Decorative article according to claim 1, wherein the first material includes at least one type of metal.

14. Decorative article according to claim 1, wherein the islands are attached to the base layer at respective interface surfaces, and wherein the islands are configured and arranged to substantially prevent the base layer from stretching at the respective interface surfaces.

15. Decorative article according to claim 1, wherein the decorative article is configured such that the decorative article is stretchable only in regions of the decorative article which are arranged at least partially between the islands.

16. Decorative article according to claim 1, wherein the islands are configured as projections which extend from the first base layer surface of the base layer.

17. Decorative article according to claim 16, wherein each projection is tapered in a direction in which the projections extend from the first base layer surface of the base layer.

18. Decorative article according to claim 16, wherein each projection has at least one of:
at least one flank, which extends from the first base layer surface of the base layer, wherein the flank forms an angle with a section of the first base layer surface, the projection being attached to said section, which is less than 90° or less than 85%; or
one or more rounded edges at one or more sections of the projections at a distal section of the projection.

19. Method for manufacturing a decorative article configured to decoratively cover at least a portion of one or more objects, including the steps of:
(a) providing a mold having a plurality of recesses which are separated from each other by one or more walls;
(b) applying at least one first material to the mold such that at least a portion of the respective recesses is filled with a deposit of first material;
(c) removing excess first material which is arranged outside of the recesses, if said excess first material is present;
(d) applying at least one second material to the mold to provide a base layer, which is substantially flexible and on which the deposits of the first material are attached; and
(e) removing the first material and the second material from the mold;
wherein a decorative article including the base layer and a plurality of discrete islands made of the first material attached to a first base layer surface at discrete positions on the first base layer surface is provided, and wherein the decorative article is elastically stretchable in regions of the base layer which are arranged at least partially between the islands.

20. Method according to claim 19, wherein, in step (b), the recesses are completely filled with the first material.
